(19) United States
(12) Patent Application Publication
(10) Pub. No.: US 2009/0265456 A1
(43) Pub. Date: Oct. 22, 2009

(54) Method and system to manage multimedia sessions, allowing control over the set-up of communication channels

(75) Inventors: Christian Bouvier, Limours (FR); Jean-Phillipe Wary, Bourg la Reine (FR)

Correspondence Address: Perman & Green, LLP, 99 Hawley Lane, Stratford, CT, 06614, US

(73) Assignee: SOCIETE FRANCAISE DU RADIOTELEPHONE (SFR), Paris (FR)

(21) Appl. No.: 11/949,375

(22) Filed: Dec. 3, 2007

(30) Foreign Application Priority Data
Dec. 6, 2006 (FR) 06 10630

(51) Int. Cl. G06F 15/173; G06F 21/00

(52) U.S. Cl. 709/224; 726/22

(57) ABSTRACT

Managing multimedia sessions including surveying anomalies representing illicit uses of a determined signalling protocol, determining reactions in relation to the identified anomaly, collecting all requests exchanged between a client terminal and a proxy server, analysing collected requests for detection of anomalies, through the use of a plurality of indicators each associated with one of the identified anomalies, and in the event of the detection of at least one anomaly, triggering by the proxy server of a reaction corresponding to the detected anomaly, the reaction including real-time action during the communication concerned by the message containing the anomaly. The method therefore allows the real-time detection and filtering of hidden channels utilised in a signalling protocol such as SIP.

### BACKGROUND

1. Field

The disclosed embodiments are directed towards telecommunications, more particularly for the purpose of controlling the establishing of communication channels in a network managed by an operator, and towards a method for managing multimedia sessions.

2. Brief Description

Voice over IP technology (Internet Protocol) or VoIP and, more generally, technologies enabling the setting up of multimedia sessions most frequently use the SIP protocol (Session Initiation protocol), which is an open, interoperable standard. Other signalling protocols e.g. H323, MGCP (Media Gateway Control Protocol) and Megaco (this latter protocol was chosen by 3GPP under the UMTS standard for the control of Media Gateways) can be used for multimedia sessions.

The SIP protocol is standardized by IETF (Internet Engineering Task Force) and is described in particular by RFC 3261. The SIP protocol was designed to establish, modify and terminate multimedia sessions (see RFC 2543 for example). It takes in charge the authenticating and locating of multiple participants. It also takes in charge negotiation on the types of media which can be used by the different participants, by encapsulating SDP messages (Session Description Protocol). The SIP protocol does not convey the data exchanged during the session, such as voice or video. Since this protocol is independent of data transmission, any type of data and protocol can be used for this exchange: it is most often the RTP protocol (Real-time Transport Protocol) which ensures audio and video sessions. One advantage of the SIP protocol is that it is not only intended for Voice over IP, but also for numerous other applications such as video teleconferencing, instant messaging, virtual reality or even video games.

One problem related to this type of technology is that Voice over IP protocols and associated services were defined without any consideration given to security. In particular as regards SIP, it is possible to give service denial, to re-route communications, to listen to them, to telephone free of charge, to journalise calls, to create hidden channels, etc. It is even possible to be called, by usurping a Voice over IP telephone set to the detriment of the legitimate owner.

Voice over IP systems are based on the respect for the standard by clients. Therefore all that is needed is to develop one's own Voice over IP client to open up a myriad of attacking possibilities. Voice over IP technology was developed as an urgency, giving priority to multiple operating functions: choice of routing communications, group discussions etc. without taking security into account. As a result, Voice over IP is not ready for professional use by companies.

Within a radiotelephony network for example, the use of said protocols (SIP/H323/MGCP) for multimedia sessions can allow data exchanges that are undetectable by the operator. This raises problems of control over communications (hidden communication means for terrorism or organized crime) and it is not possible for the operator to invoice these communications. Since the existing standard does not freeze the syntax or utilisation of some fields, it is therefore possible to use parallel channels to disseminate information other than information needed for management of multimedia sessions: viruses, Trojan horses can be transmitted, or sensitive data can be collected unknown to subscribers, without any detection being possible by the operator. Therefore the operator cannot even meet its legal and regulatory obligations with respect to communications which are to be notified to the State on request, e.g. for administrative or legal proceedings.

Since the hidden channels used are conveyed by the signalling of Voice over IP systems, operators are not able to invoice the hidden channels and cannot meet legal or regulatory obligations.

Confronted with fraud risks on infrastructures of SIP or IMS type (IP Multimedia Subsystem) belonging to a network operator, and on IP telephony infrastructures, there is no satisfactory solution to avoid illicit uses of these infrastructures.

From document EP 1 533 977, a method is known to detect service denial attacks against devices using the SIP protocol. However, this type of method to protect the infrastructure of a SIP network is not adapted for the control of exchanges made via parallel channels in Voice over IP protocols. From document JP 2005215935 a “Firewall” interface device is known to authorize or refuse a communication, by analysing the contents of the SDP description of the message. This type of interface device does not allow control over exchanges via parallel channels, which would enable the operator to manage this type of communication.

There is therefore a need for a solution which can be applied to families having the following security problems:

identity usurpation by changing the <<from>> field, which a priori is possible on all SIP messages;

the use of hidden channels for data exchange or data theft by forcing a user to connect to a service or to another user (Bounce attack).

### SUMMARY

The object of the disclosed embodiments is therefore to eliminate one or more prior art disadvantages, by defining a method for the management of multimedia sessions, enabling the operator of a network (e.g. radiotelephony network) to detect malevolent use of the hidden channels of the SIP protocol in order to protect its clients or its income.

The disclosed embodiments aim at making advantageous use of an intermediate device acting as a buffer in the multimedia session between the client and the server. This device is called a <<proxy>> server in the remainder hereof.

For this purpose, the disclosed embodiments concern a method to manage multimedia sessions conducted according to a determined signalling protocol, between communication terminals linked by a telecommunications network, characterized in that it comprises a prior survey step of anomalies representing illicit use of the signalling protocol, and a reaction determination step in relation to the identified anomaly, the method also comprising:

a step to collect all requests exchanged between a client terminal and a proxy server; and

a step to analyse collected requests for the detection of anomalies, through the use of a plurality of indicators each associated with one of the previously identified anomalies.

Therefore, it is possible for the operator of a network to better control use of the communication channels by its clients. The operator is able to meet legal and regulatory obligations, since illicit uses of the signalling protocol can be notified.

According to one particular aspect, in the event of detection of at least one anomaly, the method comprises a triggering step by the proxy server of a reaction corresponding to the detected anomaly, said reaction including real time action during the communication concerned by the message carrying the anomaly.

According to another particular aspect, the method comprises a substitution step of identification data in each request, by the proxy server, before forwarding a message to a receiver terminal, to ensure non-propagation of hidden data between terminals.

According to another particular aspect, the analysis step of collected requests uses an anomaly indicator relating to the header of the SIP packets in the requests.

According to another particular aspect, the analysis step of collected requests uses an anomaly indicator relating to the caller identification field <<Call ID>> of each request.

According to another particular aspect, the analysis step of collected requests uses an anomaly indicator relating to a <<SUBSCRIBE/NOTIFY>> method.

According to another particular aspect, the analysis step of collected requests uses an anomaly indicator relating to one of the methods used in the SIP protocol enabling use of hidden channels.

According to another particular aspect, the analysis step of collected requests uses an anomaly indicator relating to a response code description.

According to another particular aspect, the analysis step of collected requests uses an anomaly indicator relating to the SDP field in the payload of a SIP request.

According to another particular aspect, the analysis step of collected requests uses an anomaly indicator relating to a tag of each SIP request.

The method of the disclosed embodiments therefore ensures real-time detection and filtering of hidden channels used in a signalling protocol such as SIP.

According to another particular aspect, said reaction comprises an invoicing step which is related to the detected anomaly, in which data required for invoicing (paying heed to an operator's legal obligations) are transmitted to a dedicated server called an invoicing server.

This reaction leaves use of the hidden channels available to users.

According to another particular aspect, said reaction comprises transmission of an alert message for real-time notification of at least one anomaly to a monitoring centre, monitoring the IP part of the network.

According to another particular aspect, the method comprises a management step by a conversion module associated with the proxy server, for one same SIP request, managing a pair of fields in which a second field is rewritten from the first field.

According to another particular aspect, during said reaction, the method comprises a cut-off step of the SIP session.

It is therefore possible to prevent the propagation of a data item inserted <<hidden>> fashion into a field of a signalling protocol used in particular for the Voice over IP service.

A further purpose of the disclosed embodiments is to provide a solution to one or more problems encountered in the prior art, by defining a system with which it is possible to manage multimedia sessions with control over utilisation of the communication network resources.

For this purpose the disclosed embodiments concern a system to manage multimedia sessions, intended to be used in a network of SIP type between at least one client terminal and a SIP proxy server, characterized in that it comprises:

a storage device to store anomaly indicators representing illicit uses of the signalling protocol;

an anomaly survey module, coupled to said indicators, provided with an analysis function of SIP requests to collect all SIP requests exchanged between each of the client terminals and the SIP proxy server;

reaction modules each programmed to command an action in relation to the identified anomaly, each reaction module being activated by the proxy server and triggering real-time action during a communication concerned by the message comprising the anomaly.

Therefore, with said system, it can be ensured that no SIP request covers a <<hidden>> communication channel (indicators relating for example to the abnormal size of some fields or to the unusual repetition of some processes effectively allow the detection of roundabout use of the signalling protocol).

According to another particular aspect, a conversion module is provided in the proxy server which, for one same SIP request, manages two different fields of which a second field is rewritten from a first field using a rewrite module of the conversion module.

Therefore, any roundabout use of a signalling protocol field is made impossible by the rewrite operation: additional information cannot therefore be propagated via this field.

A further object of the disclosed embodiments is to propose a network with which it is possible to oppose illicit use of hidden channels of the SIP protocol.

For this purpose, the disclosed embodiments concern a network using the SIP protocol, comprising a plurality of network elements, characterized in that it comprises the management system of multimedia sessions according to the disclosed embodiments.

### BRIEF DESCRIPTION OF THE DRAWINGS

The disclosed embodiments, with its characteristics and advantages, will become more clearly apparent on reading the description which refers to the appended figures given as non-limiting examples in which:

FIG. 1 is a logical diagram of the steps of the method in one embodiment of the disclosed embodiments;

FIG. 2 shows a network allowing management of multimedia sessions according to the disclosed embodiments;

FIG. 3 illustrates a first scenario of a call which can be detected by use of an indicator of a system according to the disclosed embodiments;

FIG. 4 illustrates a second scenario of a call which can be detected by using an indicator of a system according to the disclosed embodiments;

FIG. 5 schematically illustrates an IP Multimedia Subsystem (IMS) context, in which the network of a radiotelephony operator is equipped with a system to monitor and manage SIP requests according to one embodiment of the disclosed embodiments.

### DETAILED DESCRIPTION

The SIP protocol is designed to establish, modify or terminate multimedia sessions. The protocol is in charge of negotiating the types of media which can be used by the different participants by encapsulating SDP messages (Session Description Protocol). On the other hand, the SIP protocol must not convey exchanged data, such as voice or video, during the session.

The method to manage multimedia sessions according to the disclosed embodiments, aims at treating all the vulnerabilities of signalling protocols such as SIP. The disclosed embodiments provide for detection, filtering and reaction functionalities to limit and even to eliminate the possible use of signalling messages to transmit hidden information (via hidden channels). As a non-limiting example for the SIP protocol, the utilisations of hidden channels can be listed as follows:

MESSAGE method;

SUBSCRIBE/NOTIFY method;

Header of SIP packets (session characteristics);

Response code description (req 200 OK);

SDP payload field;

Caller ID (@<CSeq>!!!);

TAG.

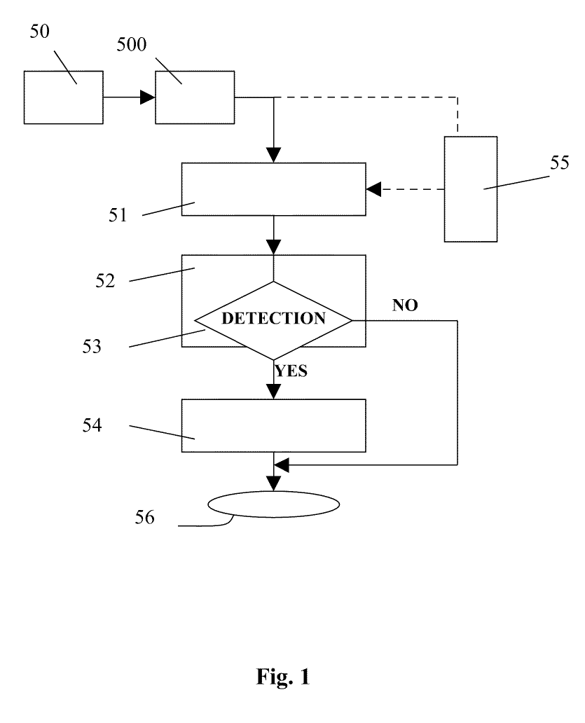

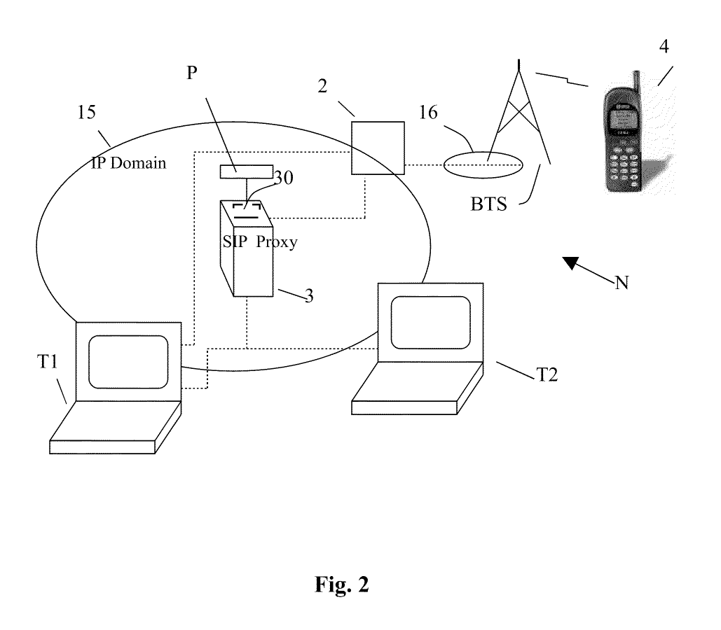

With reference to FIG. 2, the SIP network N includes a first domain 15 of IP protocol (Internet Protocol) allowing the use of a topology of routing options (dotted lines) and a second domain corresponding to a radiotelephony network 16. A domain of public switched telecommunications network type (PSTN) may also form part of the SIP network N. In one preferred embodiment, the SIP network N illustrated FIG. 1 uses a service architecture with an IMS sub-system (IP Multimedia Subsystem), which allows deployment of Voice over IP technology. Although the SIP network N is shown as including a radiotelephony network 16 provided with stations as well as a part with wire connection, it is to be appreciated that any wireless connection may be used in the network N, this network possibly even using wireless connections only (radio, WiFi, Wimax, Bluetooth®, etc.).

In the example shown FIG. 2, the IP domain 15 has a plurality of network elements, in particular a media gateway 2, a proxy server 3 and first and second user terminals T1, T2. Each terminal T1, T2 can use a portion of the topology of the routing options when a communication is set up with a wireless communication terminal 4, e.g. a cell terminal, via the wireless telephony network 16. In this case, the proxy server 3 and the gateway 2 are used. The first and second terminals can also communicate together via the SIP proxy server 3, without using the gateway in this case.

In one embodiment of the disclosed embodiments, a function to collect and analyse SIP requests is implemented in the SIP proxy server 3 and/or in the gateway 2. Said function may optionally, for some needs, be implemented in at least one of the user terminals T1, T2. The analysis function advantageously allows SIP requests to be filtered in order to detect anomalies representing illicit use of <<hidden>>, channels.

The SIP network N may be provided with an anomaly survey module 30, which has an analysis function of SIP requests. This anomaly survey module 30 is used to collect all SIP requests exchanged between each of the client terminals T1, T2, 4 and the SIP proxy server 3. It can also collect SIP requests transmitted via the gateway 2 derived from another IP network and sent to a client terminal T1, T2, 4. It can also collect SIP requests transmitted from a client terminal T1, T2, 4 via the gateway 2 to another IP network. This anomaly survey module 30 can be arranged at the proxy server 3. Alternatively, several anomaly survey modules 30 can be provided in the SIP network N, preferably in network elements of the IP domain 15.

With the method of the disclosed embodiments, it is possible to manage and control multimedia sessions conducted following a determined signalling protocol (e.g. SIP) between the communication terminals T1, T2, 4 connected to the network N. With reference to FIG. 1, the method comprises for example:

a survey step 50 of anomalies representing illicit uses of the signalling protocol;

a step 500 to define reactions in relation to the identified anomaly;

a step 51 to collect all the requests exchanged between a client terminal and a proxy server;

an analysis step 52 to analyse collected requests and detect anomalies, through use of a plurality of indicators each associated with one of the identified anomalies.

In the event of detection 53 of at least one anomaly, the method makes provision in the example shown FIG. 1 for a trigger step 54, by the proxy server 3, of a reaction corresponding to the detected anomaly. This reaction may advantageously include real-time action during the communication concerned by the message containing the anomaly. It is thus understood that the method allows detection and filtering on the signalling protocol of the network N, e.g. between the client terminal T1, T2, 4 and the proxy server 3. The collecting of all the requests made using the same signalling protocol (SIP or similar signalling protocol) allows the management of sessions to be centralized. All the requests exchanged between a client terminal T1, T2, 4 and the communication proxy server 3, and vice versa, can therefore be analysed.

It can advantageously be ensured that no information is propagated between subscribers through the infrastructure, subsequent to the detection of anomalies. Thresholds can be used to detect the size of an unusual Caller-ID. In the example of the SIP infrastructure, as illustrated FIG. 2, the method of the disclosed embodiments can for example prevent extension of CALL_ID information from a transmitter towards a receiver. In said embodiment of the disclosed embodiments, it is possible, at a conversion or function module P of the SIP network N, to manage two different CALL_ID fields: one dedicated to each of the transmitter/Communication proxy exchanges, and a second dedicated to each of the Communication proxy/receiver exchanges. Said function P is associated with the survey module 30 in the example shown FIG. 2.

With reference to FIG. 1, a substitution step 55 of identification data can be performed for each of the requests, by the proxy server. This substitution step 55 is performed before forwarding a message to a receiver terminal, to ensure non-propagation of hidden information between terminals.

The method of the disclosed embodiments enables application of an analysis filter of behavioural type, or signature-based, in order to detect anomalies of illicit uses. The behavioural approach consists of analysing whether a user has shown abnormal behaviour relative to usual utilisation of SIP transactions. The scenario approach requires a database of abnormal signatures to conduct analysis. A comparison of these signatures with the captured packets is used to determine whether there is or is not illicit use. This is called <<pattern matching>>. Alternatively or complementary fashion, the method can use the P function to correlate events and to react according to defined scenarios (blocking of the communication, issue of invoice ticket, etc.). The setting up of communication channels is therefore advantageously controlled by means of filtering performed in the IP domain 15, on SIP requests (or similar signalling protocol). In one embodiment of the disclosed embodiments, the action carried out on a request message that is associated with a detected anomaly does not prevent the forwarding 56 of the request to the receiver terminal. In this case, the method may make provision for the issue of additional invoicing for use of a hidden channel.

The anomaly indicators are parameterised to allow verification of use of hidden channels. The transmission of data via signalling messages for the purpose of avoiding call charging and/or registration can then be detected and even invoiced. The indicators take SIP modularity into account and correspond to each type of hidden channel which could convey information. The example of the SIP message illustrated in the annex reproduces the syntax of SIP messages. SIP messages are coded using the message syntax http/1.1 (RFC 2068). The set of characters used is defined under standard ISO 10646 and uses UTF coding (RFC 2279). The lines end with CR LF characters (Carriage Return, Line Feed). Two types of messages exist: requests and responses. Some header fields are present both in requests and in responses and form the general header (such as Call-ID, CSeq, from, to and via). The organisation of a SIP request let perceive weakness to be found to use the fields in a manner that is hidden vis-à-vis the network. According to the management method of the disclosed embodiments, as many indicators may be provided as techniques for the hidden forwarding of information, for example:

an indicator for abnormal use of the Message method;

at least one indicator to control abnormal filling of the various headers of SIP packets;

an indicator for SDP payload fields;

an indicator for abnormal filling of the response code description;

indicators for Call-ID, tag and branch. With reference to FIGS. 1, 2 and 5, collection step 51 may consist of capturing all TCP or UDP/SIP exchanges. SIP transactions are grouped together using the <<Cseq>> headers for example. Each transaction is effectively identified by a common value of the <<Cseq>> header which is an identifier used to link requests to corresponding responses within a SIP transaction. The identifier consists of the name of the method used and of a sequence number which may be random. Responses to a request must have an identical <<Cseq>> header to the request.

The analysis step 52 of collected requests corresponds for example to filtering which is applied to the traffic of SIP transaction according to different analysis methods, particularly in order to detect one or more of the following items:

analysis of traffic anomaly by detecting changes in traffic typologies e.g. increased frequency of requests, high number of requests/responses in one same transaction, increase in error code (code 480 <<temporarily unavailable>>).

increase in the sizes of the different fields of the SIP protocol.

Indicators with a detection threshold are used to recognize an abnormal increase in a SIP protocol field. Indicators with an occurrence threshold of a repeated or abnormal event are also used. The anomaly survey module 30, in the event of a detected anomaly, provides information allowing one or more reaction modules to be selected (not shown) each programmed to command an action in relation to the identified anomaly. Each reaction module is activated for example by the proxy server 3 and triggers a real-time action during a communication concerned by the message containing the anomaly. The reaction modules may naturally be grouped within one same action module.

Detection by threshold (e.g. header field too big) and the statistical decision that abnormal behaviour is detected (too many exchanges of signalling messages whose result is failed set-up of a communication and hence non-traceability of communications in a short time lapse) are operating functions available to the anomaly survey module 30. Once a threshold is reached, the function P associated with module 30 can, as a non-limiting example, issue a charge ticket identifying the transmitter and receiver to indicate that a communication is in progress and to initiate <<accounting>> for invoicing. In this case, there is therefore a notion of maintaining a communication context which manages a multiplicity of counters related to several utilisations and in particular the size of scanned headers which can be used to evaluate the volume of exchanged data. Supplementary filtering can also be used to analyse MESSAGE packets or the packets of the other methods offered by the SIP protocol (e.g. SUBSCRIBE/NOTIFY).

In one embodiment of the disclosed embodiments, the reaction module, depending on the abnormal events detected, performs one or more pre-parameterised scenarios such as:

Cut-off of the SIP traffic transaction;

Generation of an invoicing ticket;

Sending of a notification alert in real time, to a monitoring centre of the network IP part 15.

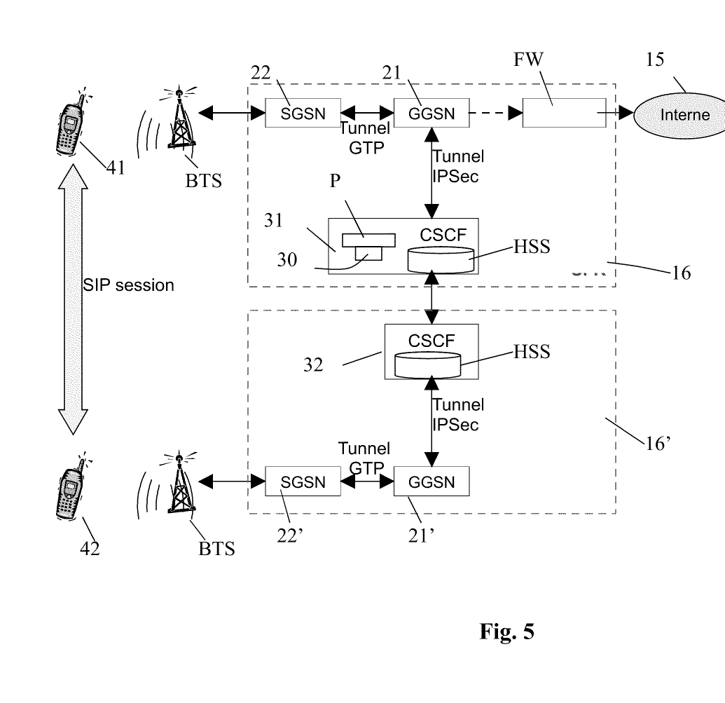

The filtering of SIP flows (or flows of a similar protocol) involves a prior step 50 to survey anomalies. The anomaly indicators are available to the survey module 30. The collection step 51 becomes possible through the insertion of a management system according to the disclosed embodiments, in the infrastructure of the mobile operator. For example this system ensures the interception of SIP flows between the client terminal T1, T2, 4 and the proxy server 3. All bilateral SIP transactions between the terminal T1, T2, 4 and the server 6 are captured. In the example shown FIG. 5, a function P associated with the anomaly survey module 30 is positioned at the SIP proxy server 3 of a first radiotelephony network 16. This function P enables SIP requests to be managed and prevents the use of hidden channels via the first radiotelephony network 16. In this manner, a SIP session between two terminals 41, 42 communicating via different radiotelephony networks 16, 16′ can be set up with control over utilisation of the SIP protocol to prevent illicit use of possible hidden insertions within the requests.

The embodiment shown FIG. 5 illustrates the infrastructure of two different radiotelephony operators with a communication between these networks via CSCF servers 31, 32 (Call Session Control Function) provided for example with an HSS database (Home Subscriber Server) to recover subscriber data. Gateways 21, 21′ and switches 22, 22′ provided in each of these radiotelephony networks 16, 16′ allows messages to be forwarded to wireless communication mobile terminals 41, 42. A GTP protocol (GPRS Tunnel Protocol) is used to communicate between a gateway 21, 21′ of GGSN type (Gateway GPRS Support Node) and a switch 22, 22′ of SGSN type (Serving GPRS Support Node). A firewall FW can be placed at the interface between at least one of the radiotelephony networks 16 and the domain 15 of Internet type.

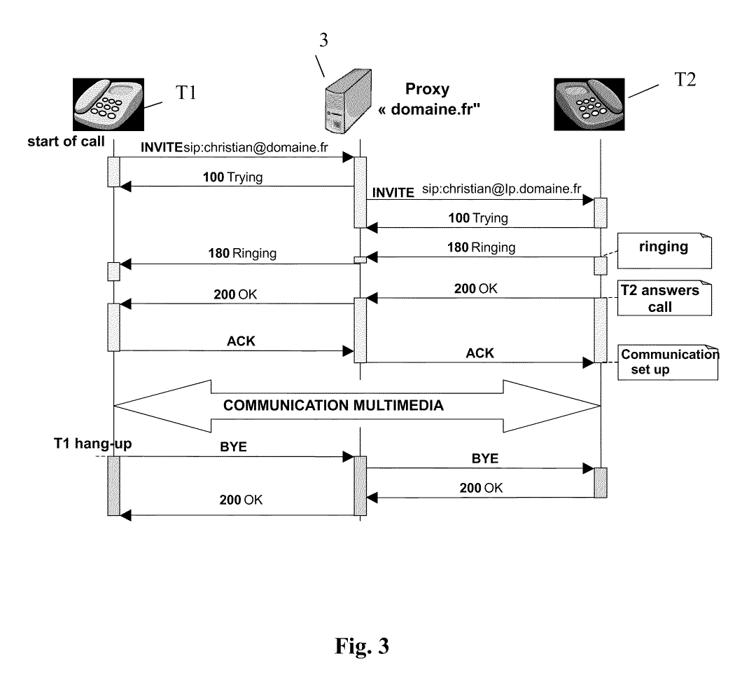

FIG. 3 recalls the conventional proceeding of a call scenario using a signalling protocol. Simple communication scenarios use SIP requests such as: INVITE, ACK, BYE. A SIP client terminal T1 calls another terminal T2 using the INVITE message. The sent message contains information allowing media flows to be set up towards the caller client terminal T1. The example below illustrates an invite message according to SIP protocol:

INVITE sip christian@domaine.fr SIP/2.0

Via: SIP/2.0/UDP {my private address: port}; branch={branch}

Max_forwards: 70

From: {“Christian”}<sip: {christian domaine.fr}>;

To: {Paul}<sip: {paul@ domaine.fr}>

Call-ID: {2966324558-edc-6548-fg8g9}

CSeq: {1} INVITE

Expires: 1800

Content-Length: {187}

A SIP server, for example the proxy server 3 of the <<domaine.fr>> domain, replies to a SIP request by means of one or more responses. The majority of responses whose codes have the form 2xx, 3xx, 4xx, 5xx, and 6xx are <<final>> responses and terminate the transaction in progress. Responses of form 1xx are provisional responses. An example of a response is given below:

SIP/2.0 100 Trying

Via: SIP/2.0/UDP {my private address: port}; branch={branch}

From: Paul}<sip: {pauldomaine.fr

To: { }>{“Christian”}<sip: {christian domaine.fr}>;

Call-ID: {2966324558-edc-6548-fg8g9}

CSeq: {1} INVITE

In the example in FIG. 3:

the response code <<100>> means <<Trying>>;

the response code <<180>> means <<Ringing>>; and

the response code <<200>> means <<OK>>.

To understand the notion of transactions and retransmission of messages, it is recalled that a SIP dialogue is identified by the combination of the fields <<From>>, <<To>>, Call-ID and the sequence number <<Cseq>>. When the dialogue is opened, all requests and all responses must include these header fields. Each transaction is identified by the common value of the <<Cseq>> header (the name of the method and the sequence number must be identical). The system according to the disclosed embodiments can be used, in each transaction, to analyse the type of requests sent with the associated responses, and to make a comparison between the transactions.

In one embodiment of the disclosed embodiments, the management system particularly allows monitoring of the repetition of signalling protocol sessions to detect the use of hidden channels, such as the sending of a file in the <<Call-ID>> header. For this type of session, the communication between a sender terminal T1 and a receiver terminal T2 proceeds as follows:

first, the sender T1 sends an INVITE message to the receiver T2 passing data in the Call-ID;

the receiver T2 replies with the code <<480 Temporarily unavailable>> and the same Call-ID; return of the 480 code therefore means that the user of terminal T2 refuses the call;

code 480 thus returned enables the sender T1 to ensure that the receiver T2 has indeed received the INVITE message, and this sender T1 continues by sending an acknowledgement message ACK with the same Call-ID to confirm closure of the SIP session.

In this case, the proxy server 3 considers that the call never arrived and that the session is terminated. Since an INVITE-480-ACK sequence is considered to be an unsuccessful call, it is fully possible to send a succession of several sequences of this type in order to transmit data. It will be appreciated that a high number of sequences of this type must be considered abnormal. The system of the disclosed embodiments allows easy detection of this type of anomaly by means of an indicator particular to this anomaly.

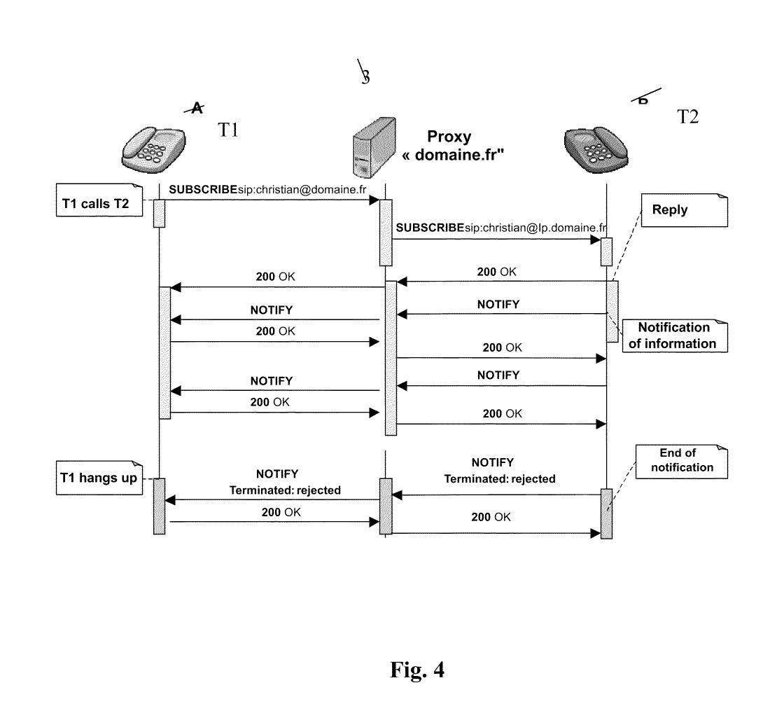

With reference to FIG. 4, generic requests such as SUBSCRIBE and NOTIFY can also be controlled using the indicators available to the system of the disclosed embodiments. The utilisation of SUBSCRIBE and NOTIFY requests can be monitored and a reaction can be triggered e.g. if multimedia content is exchanged via hidden channels. These two generic requests can be routed by the proxy servers 3 using the headers <<From>> and <<To>> and are acknowledged by responses. The SUBSCRIBE request is sent by a client terminal T1, wishing to receive certain events, to a server 3 which generates events (e.g. request for information on presence in a <<buddy list>> application). The SUBSCRIBE request contains <<Expires>> in the header indicating the subscription period. The NOTIFY request is used to send notice of events.

These SUBSCRIBE and NOTIFY requests can create a SIP dialogue, they do not need an INVITE request and can be sent asynchronous fashion at any time. A network operator, by means of a system according to the disclosed embodiments, can control this dialogue. All that is needed is to integrate this type of scenario in the analysis and filtering device. The anomaly survey module 30 can have at its disposal an indicator relating to a succession of events comparable to the steps enabling a SIP dialogue to be initiated in illicit fashion.

One of the advantages of the disclosed embodiments is to allow the monitoring of messages in real time, so that the operator is able to control the use of parallel channels in Voice over IP protocols. Therefore all the parallel channels available via the SIP protocol can be controlled by a system managing SIP requests according to the disclosed embodiments. The mapping of available parallel communication means can be used to provide relevant indicators which can be used by the anomaly survey module 30.

Each description of tests needed to discover parallel communication means can be sequentially pre-coded. A grammar can describe the list of signalling protocol fields which the anomaly survey module 30 could use and evaluate. Once mapping is completed, it could be envisaged to assess the bandwidth available for each of the parallel channels by a succession of recurrent tests on the availability of the mapped parallel channels.

To ensure that no content is transmitted in parallel by the Call_ID field, the system of the disclosed embodiments can specify (e.g. rewrite) this field. This rewrite can be made via the P function associated with the proxy server 3 for example. In this case the P function manages two different CALL-ID fields so as not to propagate data via this field. Simple rewrite at the proxy server 3 can prevent propagation, as can be appreciated those skilled in the art (a technique known per se with enrolment, overwrite on fields of initially recorded data, etc.). The number of characters in this type of field will therefore be limited through the rewrite operation made by the conversion function P. Other fields and parallel channels can be managed similarly.

It will be obvious for persons skilled in the art that the disclosed embodiments allow embodiments in numerous other specific forms without departing from the scope of application of the disclosed embodiments as claimed. Therefore, the present embodiments are to be considered as illustrations which can be modified in the area defined by the scope of the appended claims, and the disclosed embodiments are not to be construed as being limited to the details given above.

### ANNEX

### Example of SIP Message

INVITE sip:jacques@mondomaine.fr SIP/2.0
Via: SIP/2.0/UDP 139.100.184.12 : 5040
Via: SIP/2.0/UDP sipserv.mondomaine.fr :

5060

Max-Forwards: 70
To: Jacques <sip:jacques@ mondomaine.fr>
From: Paul <sip:paul@mondomaine.fr>
Call-ID: 2966324558-edc-6548-fg8g9
CSeq: 1 INVITE
Content-Type: application/sdp
Content-Length: 187
<payload SDP>.

1. Method to manage multimedia sessions conducted according to a determined signalling protocol, between communication terminals linked via a telecommunications network, the method comprising a prior step (50) to survey anomalies representing illicit uses of the signalling protocol, and a step (500) to determine reactions in relation to the identified anomaly, the method also comprising:
a step (51) to collect all requests exchanged between a client terminal (T1, T2, 4) and a proxy server (3);
a step (52) to analyse collected requests in order to detect anomalies through use of a plurality of indicators each associated with one of the previously identified anomalies.

2. Method according to claim 1 which, in the event of detection (53) of at least one anomaly, comprises a triggering step (54) by the proxy server (3) to trigger a reaction corresponding to the detected anomaly, said reaction including real-time action during the communication concerned by the message containing the anomaly.

3. Method according to claim 1, comprising a step (55) substituting identification data in each request, by the proxy server, before forwarding a message to a receiver terminal, to ensure the non-propagation of hidden data between terminals.

4. Method according to claim 1, wherein the analysis step (52) of collected requests uses an anomaly indicator relating to the header of request SIP packets.

5. Method according to claim 1, wherein the analysis step (52) of collected requests uses an anomaly indicator relating to the identification field of the caller, <<Call ID>>, of each request.

6. Method according to claim 1, wherein the analysis step (52) of collected requests uses an anomaly indicator relating to a SUBSCRIBE/NOTIFY method.

7. Method according to claim 1, wherein the analysis step of collected requests uses an anomaly indicator relating to one of the methods used in the SIP protocol enabling utilisation of hidden channels.

8. Method according to claim 1, wherein the analysis step (52) of collected requests uses an anomaly indicator relating to a response code description.

9. Method according to claim 1, wherein the analysis step (52) of collected requests uses an anomaly indicator relating to the SDP field in the payload of a SIP request.

10. Method according to claim 1, wherein the analysis step (52) of collected requests uses an anomaly indicator relating to a tag of each SIP request.

11. Method according to claim 2, wherein said reaction comprises an invoicing step related to the detected anomaly, in which information required for invoicing and meeting the operator's legal obligations, is transmitted towards a dedicated invoicing server.

12. Method according to claim 2, wherein said reaction comprises transmission of an alert message to notify at least one anomaly in real time to a centre monitoring the IP part (15) of the network (N).

13. Method according to claim 1 comprising a management step by a conversion module (P), associated with the proxy server (3), which for one same SIP request manages a pair of fields in which a second field is rewritten from the first field.

14. Method according to claim 2, wherein the reaction comprises a step to cut off the SIP session.

15. System to manage multimedia sessions, intended to be used in a network of SIP type between at least one client terminal (T1, T2) and a SIP proxy server (3), the system comprising:
a storage device to store anomaly indicators representing illicit uses of the signalling protocol;
an anomaly survey module, coupled to said indicators, provided with an analysis function of SIP requests to collect all SIP requests exchanged between each of the client terminals (T1, T2) and the SIP proxy server (3);
reaction modules each programmed to command an action in relation to the identified anomaly, each reaction module being activated by the proxy server (3) and triggering action in real time during a communication concerned by the message containing the anomaly.

16. Management system according to claim 15, wherein a conversion module (P) is provided in the proxy server (3) and which, for one same SIP request, manages two different fields of which a second field is rewritten from a first field using a rewrite module of the conversion module (P).

17. Network (15) using the SIP protocol, comprising a plurality of network elements, comprising the system to manage multimedia sessions according to claim 15.
